(19) United States
(12) Patent Application Publication
(10) Pub. No.: US 2024/0406094 A1
(43) Pub. Date: Dec. 5, 2024

(54) BYPASS ROUTING

(71) Applicant: Tesla, Inc., Austin, TX (US)

(72) Inventor: Douglas R. Williams, Mountain View, CA (US)

(21) Appl. No.: 18/683,600

(22) PCT Filed: Aug. 16, 2022
(86) PCT No.: PCT/US2022/040495

§ 371 Date: Feb. 14, 2024

Related U.S. Application Data
(60) Provisional application No. 63/367,568, filed on Jul. 1, 2022.
(60) Provisional application No. 63/260,437, filed on Aug. 19, 2021.

(51) Int. Cl. H04L 45/28; H04L 45/00; H04L 45/18

(52) U.S. Cl. CPC H04L 45/28; H04L 45/18; H04L 45/22

(57) ABSTRACT

Systems and methods for routing packets around dead dies in an array are disclosed. In some embodiments, a method for routing a packet in a die array that include a dead die can include routing a packet from a first die to a second die by way a first channel of a plurality of first channels and routing the packet from the second die to a third die by way of a second channel of a plurality of second channels based on one or more routing rules. The one or more routing rules can allow the first channel to route the packet to a subset of the plurality of second channels that includes the second channel. The second channel can be orthogonal to the first channel such that routing the packet from the first die to the third die involves a turn. The method can route the packet around the dead die.

### CROSS-REFERENCE TO RELATED APPLICATIONS

This application claims the benefit of U.S. Provisional Application No. 63/260,437, filed Aug. 19, 2021, titled “Bypass Routing,” and U.S. Provisional Application No. 63/367,568, filed Jul. 1, 2022, titled “Bypass Routing,” the disclosures of which are incorporated herein by reference in their entireties and for all purposes.

### BACKGROUND

### Technical Field

This disclosure relates generally to signal routing in electronic circuits.

### Description of Related Technology

Certain processing systems include an array of dies. The dies of the array can include compute circuitry. The dies of the array can communicate with each other. There can be defects or damage to one or more dies of the array while most of the dies of the array are fully functional. In such a processing system, data can be routed around one or more inoperable dies.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

In some aspects, the techniques described herein relate to a method of dead die bypass routing, the method including: routing a packet from a source die to an intermediate die via a first route, the first route including turning the packet from a first channel of a plurality of first channels to a second channel of the plurality of second channels based on one or more routing rules, the one or more routing rules allowing the first channel to route the packet to a subset of the plurality of second channels that includes the second channel, and the first channel being orthogonal to the second channel; and routing the packet from the intermediate die to a destination die via a second route, the second route including turning the packet from the second channel to a third channel that is orthogonal to the second channel, wherein a system on a wafer includes a die array including the source die, the intermediate die, the destination die, and at least one dead die, and wherein the first route and the second route bypass the at least one dead die.

In some aspects, the techniques described herein relate to a method, wherein the at least one dead die includes two dead dies, and the first route and the second route bypass the two dead dies.

In some aspects, the techniques described herein relate to a method dead die bypass routing, the method including: routing a packet from a first die to a second die by way a first channel of a plurality of first channels, wherein the first die, the second die, a third die, and a dead die are included in an array; and routing the packet from the second die to the third die by way of a second channel of a plurality of second channels based on one or more routing rules, the one or more routing rules allowing the first channel to route the packet to a subset of the plurality of second channels that includes the second channel, and the second channel being orthogonal to the first channel such that routing the packet from the first die to the third die involves a turn, wherein the method routes the packet around the dead die.

In some aspects, the techniques described herein relate to a method, wherein routing the packet from the first die to the second die and the routing the packet from the second die to the third die includes: querying a routing table based at least in part on an address of the third die, wherein the routing table complies with the one or more routing rules.

In some aspects, the techniques described herein relate to a method, wherein the one or more routing rules prevent the packet from being routed in a loop.

In some aspects, the techniques described herein relate to a method, wherein each channel of the plurality of first channels and each channel of the plurality of second channels is assigned a priority, and wherein the one or more routing rules disallows turns from a lower priority channel of the plurality of first channels to a higher priority channel of the plurality of second channels.

In some aspects, the techniques described herein relate to a method, wherein a route from the first die to the third die is configured to end at a lowest priority first channel of the plurality of first channels or a lowest priority second channel of the plurality of second channels.

In some aspects, the techniques described herein relate to a method, wherein the one or more routing rules allow the packet to be routed to an escape channel, the escape channel configured to allow the packet to move to a channel with a higher priority.

In some aspects, the techniques described herein relate to a method, wherein a route from the first die to the third die includes a second turn from the second channel to a third channel, wherein the third channel has a lower priority than the second channel, and wherein second channel has a lower priority than the first channel.

In some aspects, the techniques described herein relate to a method, wherein the routing table includes a default route, the default route to be used if there is not a defined route from the first die to the second die.

In some aspects, the techniques described herein relate to a method, wherein the method routes the packet around at least two dead dies.

In some aspects, the techniques described herein relate to a method, wherein the method includes routing the packet with multiple turns.

In some aspects, the techniques described herein relate to a method, wherein a system on a wafer includes the array.

In some aspects, the techniques described herein relate to a method, further including routing the packet from the third die to a die outside of the array.

In some aspects, the techniques described herein relate to a processing system with dead die bypass routing, the processing system including: a die array including a first die, a second die, a third die, and a dead die; wherein the processing system is configured to route a packet from the first die to the third die by way of the second die to thereby bypass the dead die based on one or more routing rules implemented by circuitry of the processing system, the packet being routed by way of at least a first channel and a second channel, and the one or more routing rules allowing the first channel of a plurality of first channels to route the packet to a subset of a plurality of second channels that are orthogonal to the plurality of first channels.

In some aspects, the techniques described herein relate to a processing system, wherein the processing system is configured to route the packet from the first die to the third die by way of multiple turns.

In some aspects, the techniques described herein relate to a processing system, wherein the die array includes a second dead die, and the processing system is configured to bypass the second dead die when routing the packet from the first die to the third die.

In some aspects, the techniques described herein relate to a processing system, wherein the one or more routing rules prevent the packet from being routed in a loop.

In some aspects, the techniques described herein relate to a processing system, wherein the processing system includes a routing table storing information associated with the one or more routing rules.

In some aspects, the techniques described herein relate to a processing system, wherein each channel of the plurality of first channels and each channel of the plurality of second channels is assigned a priority, and wherein the one or more routing rules disallow turns from a lower priority channel of the plurality of first channels to a higher priority channel of the plurality of second channels.

In some aspects, the techniques described herein relate to a processing system, wherein the processing system is configured to generate neural network training data.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated into and constitute a part of this specification, and for the purpose of illustrating concepts disclosed herein and may not be to scale.

FIG. 1 is a drawing depicting an example of scatter routing.

FIG. 2 is a drawing depicting an example of multi-turn routing according to some embodiments.

FIGS. 3A-3B depict example network routes according to some embodiments.

FIG. 4 illustrates a multi-die configuration with multiple dead dies according to some embodiments.

FIG. 5 illustrates an example of a routing arrangement according to some embodiments.

FIGS. 6A, 6B, 6C, 7A, 7B, and 8 illustrate example routes of varying complexity according to some embodiments.

### DETAILED DESCRIPTION OF CERTAIN EMBODIMENTS

The following description of certain embodiments presents various descriptions of specific embodiments. However, the innovations described herein may be embodied in a multitude of different ways, for example, as defined and covered by the claims. In this description, reference is made to the drawings where like reference numerals may indicate identical or functionally similar elements. It will be understood that elements illustrated in the figures are not necessarily drawn to scale. Moreover, it will be understood that certain embodiments may include more elements than illustrated in a drawing and/or a subset of the elements illustrated in a drawing. Further, some embodiments may incorporate any suitable combination of features from two or more drawings.

When assembling multiple die onto a multi-chip module (MCM) or larger substrate, there is a possibility that some die will be damaged during the assembly process. One or more aspects of the present application relate to a mechanism to allow routing around die that are inoperable.

A packet can include control information and payload information. Control information can include, for example, a packet source, a packet destination, a packet type, a packet priority, and so forth. A packet can include, for example, data, a memory read request, a semaphore request, a barrier request, the like, or any suitable combination thereof. When packets are routed on a mesh or toroidal network, it is desirable to avoid deadlocks that can occur when multiple packets in a set of packets each desire resources that other packets in the set are using. For instance, if a device has queues A, B, and C and packets a0, a1, . . . , b0, b1, . . . , c0, c1, . . . , filling queues A, B, and C, there can be a deadlock if a0 in queue A wants to move to queue B, and b0 in queue B wants to move to queue C, and c0 in queue C wants to move to queue A, but each queue is full and waiting for a packet to leave before it can accept a new packet. One way to overcome this deadlock is to avoid all circular loops, for example, by adding rules that disallow some packet movements. In the example above, if a path is removed from queue C to queue A, then the deadlock can be broken.

An example scheme is to allow packets to travel horizontally first and then vertically. By disallowing a turn from a vertical to a horizontal channel, a system can avoid the possibility that a packet in a source channel will get stuck waiting for a target channel to drain, while the channel is waiting for the same packet to drain from the source channel. This scheme may only allow a packet to make a single turn from source to destination, which will work if the network is complete. However, if there are missing dies or inoperable dies, there could be holes in the network that result in a packet taking multiple turns to get to its destination. This scheme would not allow those packets to turn.

On a grid that spans multiple dies, instead of having only a single horizontal and single vertical channel, there can be many channels. By subdividing these sets of channels into smaller sets, and by allowing turns from one set into another, the system can allow packets to make several turns from source to destination, while still preserving the property of not allowing a circular or looped path for a packet.

For example, assume that for all horizontal channels H and all vertical channels V, a packet can travel from any H to any V channel, making one turn as it goes from source to destination. If the system divides horizontal channels into two groups H-A and H-B and likewise divides vertical channels into two groups V-A and V-B, the system could allow packets to turn from H-A to V-A, from V-A to H-B, and from H-B to V-B. Accordingly, a packet can take 3 turns to get from source to destination, which could be enough to route around a single dead die. One complication that exists is if the packet source is not present at or logically adjacent to (e.g., is not located near) an H-A row, or if the destination is not located near a V-B column. Thus, in addition to changing the labeling of the H and V network segments, the system may also add dedicated channels to get packets from each source to each H-A row, and from each V column to each destination.

In accordance with aspects of the present application, one or more benefits can be achieved over traditional implementations/approaches. Such approaches are not necessarily required for all implementations in accordance with the present application. Additional benefits or efficiencies may also be achieved in accordance with aspects of the present disclosure. Such improvements include, but are not limited to:
1) a way to label rows/columns of the network as belonging to certain sub-groups;
2) a dedicated channel or channels to route packets to a particular labeled row/column sub-group from any source;
3) a dedicated channel or channels to route packets from a particular labeled row/column sub-group to any destination; or
4) route tables that can be programmed to ensure packets can turn from particular labeled sets of rows/columns to a subset or subsets of the labeled sets of rows/columns

Embodiments described herein may be used in and/or specifically configured for high-performance computing and/or computationally intensive applications. For example, embodiments described herein may be configured for neural network training and/or processing, machine learning, artificial intelligence, or the like. Some embodiments described herein may be used for neural network training to generate data for use by an autonomous driving system for a vehicle (e.g., an automobile).

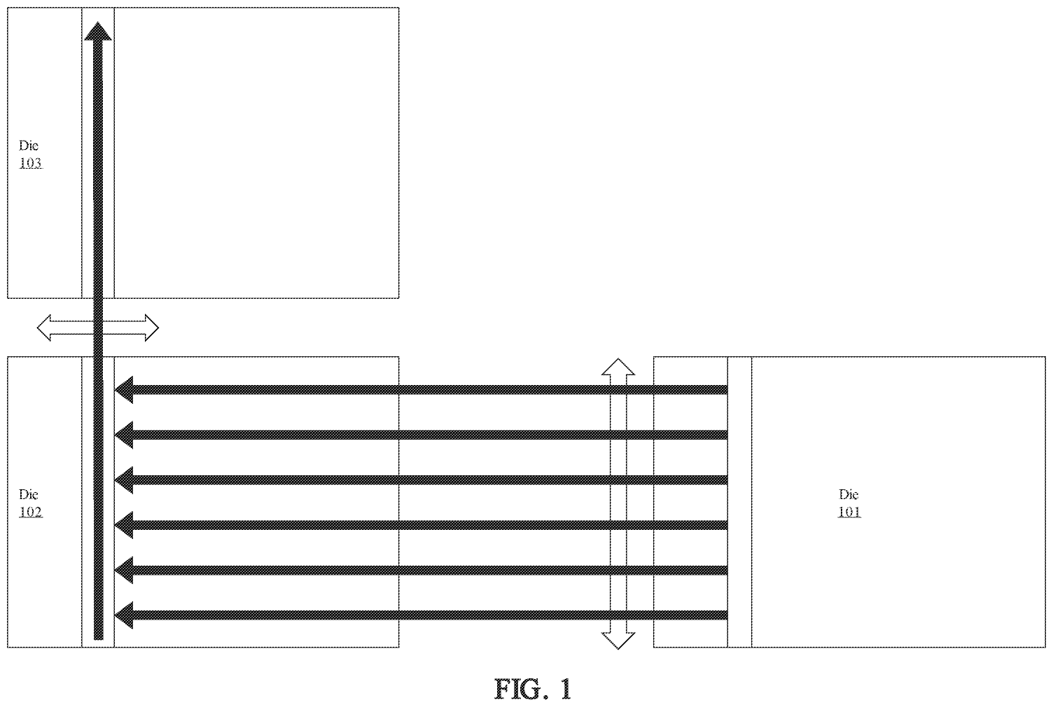

Routing packets between different dies may be carried out in a number of ways. For example, FIG. 1 depicts a scatter routing mode. In the scatter routing mode, packets can be routed from a first die 101 to a third die 103, going through a second die 102, in which only a single turn is permitted. According to the scatter routing mode of FIG. 1, nodes from a single column on the first die 101 route to a single column on the second die 102, and then to a single column on the third die 103. The traffic from the first die 101 to the second die 102 can use the full input/output (IO) bandwidth. However, traffic from the second die 102 to the third die 103 can use only part of the bandwidth, effectively limiting the bandwidth on the second part of the packet's route from the first die 101 to the third die 103.

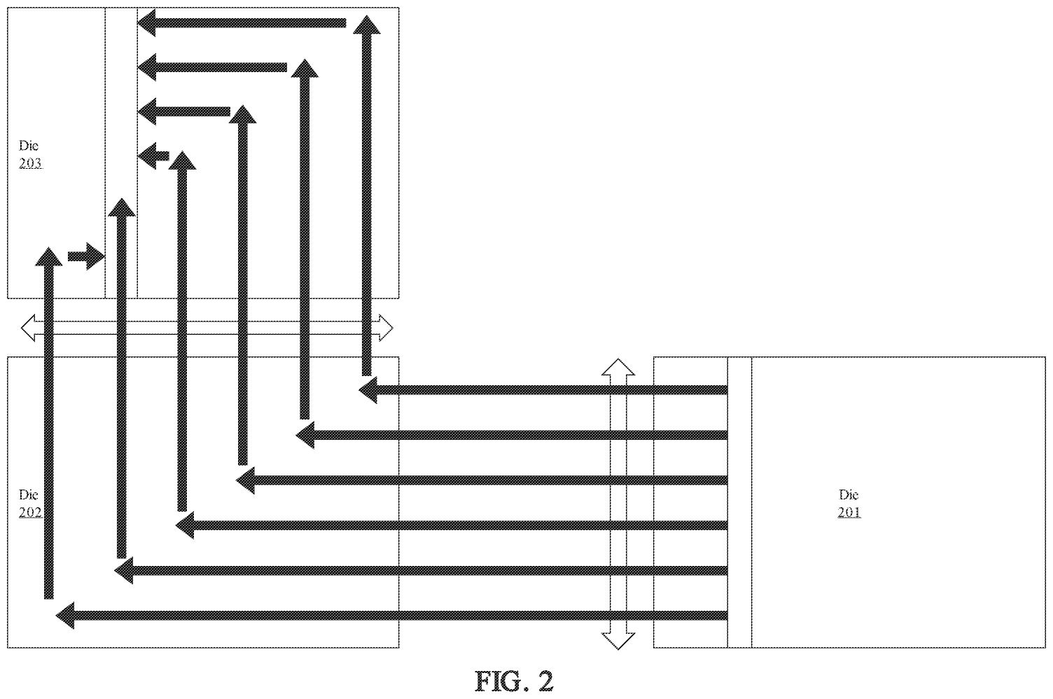

FIG. 2 depicts an alternative routing mode that allows multiple turns according to an embodiment. In the multi-turn routing depicted in FIG. 2, physical channels are grouped into virtual channels. The rows and columns can each be grouped into virtual channels. There are rules for routing traffic between virtual channels when a turn occurs. A turn can involve routing from one channel to an orthogonal channel, such as routing from (a) a row to a column or (b) a column to a row. In the illustrated routing, traffic can turn only from lower numbered (e.g., higher priority) virtual channels to higher numbered (e.g., lower priority) virtual channels. On the second die 202, each row can turn traffic into a different column. Accordingly, traffic can be scattered across the input/output interface between the second die 202 and the third die 203. This configuration allows the full bandwidth or close to the full bandwidth to be used for both segments of the path from the first die 201 to the third die 203. On the third die 203, each column can make a turn to a corresponding destination row.

Other rules for routing traffic to utilize the full bandwidth or nearly the full bandwidth of paths from one die to another that involve at least one turn can alternatively or additionally be implemented. Such rules can involve routing each row (or column) to a corresponding column (or row) or a subset of columns (or rows) when turning traffic. In some embodiments, the available bandwidth for routing may depend on the number of turns to route from a first die to a second die, which may be impacted by, for example, the number and arrangement of non-functional (dead) dies in an array of dies.

In assemblies with multiple dies, such as a system on a wafer assembly (which may include, in some embodiments, an integrated fan-out (InFO) wafer or devices prepared according to other wafer-level packaging or fan-out wafer level packaging technologies), multi-chip module, and so forth, one or more of the dies may be inoperable (dead) as a result of a manufacturing defect or damage during the assembly process. For example, a dead die itself may have internal defects (particles, impurities, cracks, broken connections, bridged connections, the like, or any combination thereof), there may be defects in the physical circuitry that enable communication with the die, and so forth. In some embodiments, a dead die may be suitable for some functions but not for others, for example because only a portion of the die is damaged. This can create significant problems for routing signals between the dies. For example, it may be desirable to route around non-functional (dead) dies.

In addition to the problem of non-functional (dead) dies, combining large numbers of dies into multi-die assemblies can create additional challenges. For example, when routing packets on a mesh or toroidal network, it is generally desirable to avoid deadlocks that can arise when a routing table or algorithm attempts to route different packets using the same resources. In some cases, this can lead to deadlock circumstances where it is not possible to allocate the resources as requested. As one example, consider two packets p, q and two queues A, B. If packet p is in queue A and packet q is in queue B, it may not be possible to swap the packets such that p is in queue B and q is in queue A.

Such problems can be eliminated or at least mitigated by imposing various routing rules for moving packets. For example, some packet movements may be disallowed. However, it is generally desirable that routing rules still enable routing around dead dies. For example, imposing a rule such as only allowing a single turn from a horizontal channel to a vertical channel, or vice versa, prevents loops but does not allow for routing around dead dies. In some embodiments, if a routing network spans multiple dies, there may be multiple vertical and horizontal channels. In some cases, the channels may be divided into smaller sets (e.g., virtual channels), and rules may allow turns from one set to another. Accordingly, packets may be permitted to make multiple turns while avoiding looping and other routing problems.

As one example, consider a network with two horizontal channels H_{A} and H_{B}, and two vertical channels V_{A} and V_{B}. A system may allow turns from H_{A} to V_{A}, V_{A} to H_{B}, and H_{B} to V_{B}. By allowing multiple turns, the system may allow routing around a single dead die. However, there may be complications where the packet source is not close to an H_{A} row or where the packet destination is not close to a V_{B} column. Thus, the system may add additional channels to route packets from each source to each H_{A} row, and from each V_{B} column to the packet's destination. One of skill in the art will appreciate that such a system may be extended any suitable number of columns and rows and that sources and destinations may originate on horizontal or vertical channels.

In some embodiments, PC0 and PC1 networks may be interleaved physical mesh networks. The PC0 network may prefer horizontal as the first travel direction, while the PC1 network may prefer vertical as the first travel direction. The networks may be otherwise identical or substantially the same or similar. In some embodiments, the PC0 and PC1 networks may be subdivided into one or more virtual channels. For example, the PC0 and PC1 networks may be subdivided into Request Hi, Request Lo, and Data virtual channels. Memory read requests may be sent along the Request Lo virtual channels, and Data responses may be sent on the Data virtual channels. The Request Hi virtual channels may be used for synchronization and timing, for example, for semaphore requests and barrier requests. In some embodiments, when the Request Hi virtual channels are full, semaphore and barrier requests may be routed over the Request Lo channels instead. In some embodiments, the virtual channels can be dynamically reallocated based on the demand for routing various types of information and requests.

In some cases, a virtual network may be used to enable routing around dead dies. For example, a system may be configured to route packets in a virtual network until they get to a die edge or a turn and may then travel in the PC0 or PC1 channels. The virtual network may use the physical PC0 channels for horizontal travel and the physical PC1 channels for vertical travel, although other routing configurations are possible. For example, the physical PC0 channels may not be restricted to horizontal travel, and/or the physical PC1 channels may not be restricted to vertical travel.

In some embodiments, various rules may be used to route packets within a die and across dies. For example, within a die, a system may force travel to be in PC0 or PC1 first, or the system may be configured to prefer a particular first network while allowing the system to route differently in some cases (for example, if the PC0 channels are busy, the system may route along PC1 first instead) In some instances, PC0 can have higher priority than PC1. In some other instances, PC1 can have higher priority than PC0. In some cases, an initial network may be selected based on a destination address of a packet. In some embodiments, there may be an error route that routes to an error queue and optionally raises an interrupt.

In some embodiments, different channels, sub-channels, columns, rows, and/or channel group can have one or more routing rules. Each can have different rules, which can enable the avoidance of loops, dead ends, and so forth when routing packets. In some embodiments, a single routing table can be used to implement the one or more routing rules, while in other embodiments, multiple routing tables can be used, for example each column or row may have its own routing table. A routing table can store information associated with the one or more routing rules. The routing table can comply with the one or more routing rules. A packet can be routed based on querying the routing table. For example, such a query can be based on an address for a destination die or an intermediate die in a route from a source die to the destination die.

In some embodiments, a multi-chip assembly may be subdivided into one or more bays. For packets that leave a die, a system may be configured to determine if a packet destination is within the bay or outside the bay. A bay may comprise, for example, a 2″×2″ grid of dies. If the destination is off the bay, the system may have a route table or other routing configuration information that can be used to route the packet to a network device used to connect bays to one another.

If the packet's destination is on the bay, the system may determine a route by looking up a table entry for the destination die address. In some embodiments, the table may comprise a k×k (e.g., 8×8) array of die addresses to map the dies. The portion of the bay covered by the array may be determined by defining minimum and maximum row and column addresses. In addition to destinations for dies, the routing table may comprise edge entries and corner entries. A row edge may comprise routes for k m×1 regions of the address map, while each column edge may comprise route entries for k l×n regions of the address map. Additionally, the routing table may include corner entries. In some cases, corner entries may be used to provide routing information for dies that live in an m/n grid of die addresses located at the overlap of each row entry and each column entry.

In some cases, the routing table may not have complete route information. The system may be configured with a default route that is used to route a packet when there is no matching table entry.

In some cases, the system may be configured with one or more auxiliary routes, and packet routing may be determined by specifying an auxiliary route rather than reading a route directly from the table. For example, a route table may have error routes, off bay exit routes, default routes (e.g., forcing or preferring a first travel network, as discussed above), routes to the die edge on PC0/PC1 networks, routes to the die edge on an escape network (E network, discussed more fully below), routes to a node row and column, then to the die edge on PC0/PC1 networks, routes to a node row and column on the E network and then to die edge, and auxiliary routes. The auxiliary routes can include any other type of route or additional routing types. For example, the route may be on the PC0/PC1 or E networks to a row and column specified by a field, and then to an edge.

In some configurations, multiple nodes may be connected to each other. Thus, a system may include a table of routes that describes how to handle an arriving packet. If an arriving packet is addressed to a location on the node, a local grout route may be used to route the packet to its destination. The packet may be routed directly to its destination or may be routed to a row and column specified by the node address and then turned to reach the destination. In some embodiments, turns may be configured so that the packet stays in the PC0 or PC1 network, PC0 crosses onto PC1, or PC1 crosses onto PC0. In some cases, turns may be disallowed and thus any attempt to turn may result in an error.

In some cases, a packet may travel across a die on the way to a final destination. The system may be configured with a routing table that permits various types of routes. For example, a packet may be routed directly across a die without changing networks (i.e., staying in PC0 or PC1) or may be routed to a node row and column and then turn to route to an edge. In the case of turning, the system may include global bits that define whether the packet will stay in the PC0 or PC1 network, or whether transfers from one network to the other are permitted. In some embodiments, routing may be determined based on a hash, and again transfers may be allowed or disallowed between PC0 and PC1 networks. Additionally, packets may be routed along auxiliary routes (e.g., to a specific row or column and then turn, either onto the same or a different network), or to an error queue.

### Routing Constraints and Routing Around Dead Dies

As discussed above, deadlock situations can arise when routing packets. A routing algorithm may use fixed routes with limited sets of available turns. For example, consider a system with queues 0, 1, and 2. If all queues are full and the system wants to move queue 0's contents to queue 1, queue 1's contents to queue 2, and queue 2's contents to queue 0, the system will deadlock. Thus, one rule may allow packets to only route to queues with a higher number. Thus, for example, queue 0 could move to queue 1 and queue 1 could move to queue 2, but queue 2 could not move to queue 0. Another example rule is to allow packets to only route to queues with a lower number. Rules can have queues route packets to only a subset of available queues.

In a 2-dimensional mesh (e.g., with PC0 and PC1 networks as described above), packets may travel through sequential queues as they travel straight across a set of nodes. In some embodiments, the queues may be labeled separately. However, in some cases, for example when there is no possibility of wrapping around, the queues may be labeled collectively as a channel.

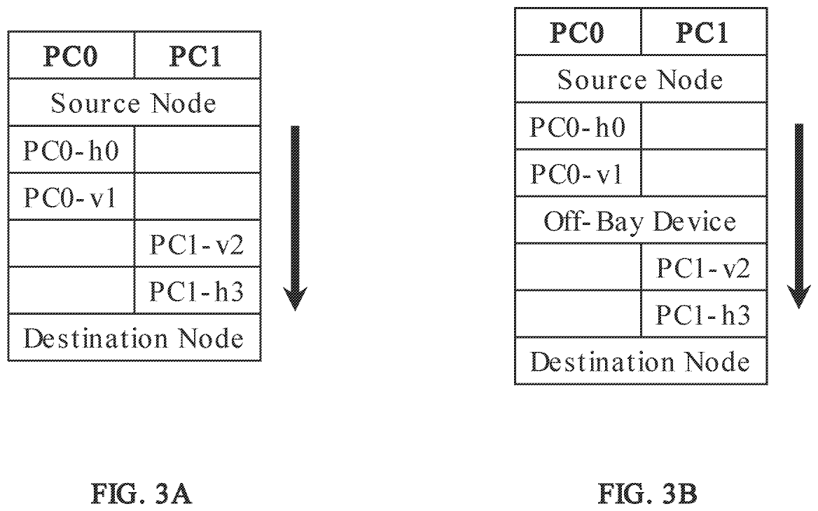

As an illustrative example, as depicted in FIG. 3A, all PC0 network horizontal queues may be numbered 0, and all PC0 network vertical queues may be numbered 1. Routing rules can specify that a packet can be routed to a higher numbered queue (also referred to herein as a lower priority queue) but not to a lower numbered queue. Thus, a packet can turn from any PC0 horizontal channel to any PC0 vertical channel but cannot turn from a PC0 vertical channel to a PC0 horizontal channel. Similarly, the PC1 vertical channels may be numbered 2 and the PC1 horizontal channels may be numbered 3. Thus, a packet could turn from a PC1 vertical channel to a PC1 horizontal channel. Under the routing rules, the packet could not turn from a PC1 horizontal channel to a PC1 vertical channel.

Additional complications can arise when routing off bay (e.g., to a die in another system, to a field programmable gate array (FPGA), etc.) or when routing around dead die. For example, when routing off bay traffic, the system lacks control over the switching topology that connects bays to one another. Preferably, loops that travel through the same network switch can be avoided. Thus, in some embodiments, traffic that travels to an off-bay device (e.g., an FPGA) may be kept on one set of channels while traffic that travels from the off-bay device may be kept on another set of channels. In some embodiments, the channels for sending traffic to the off-bay device may be lower numbered than the channels receiving traffic from the off-bay device.

For example, FIG. 3B depicts an example of routing to an off-bay destination according to some embodiments. According to FIG. 3B, a system may route a packet to an off-bay device using channels 0 and 1. The system may then route the packet to the destination node using channels 2 and 3. In this configuration, a switch to transfer traffic to the off-bay device is considered to be an intermediate channel 1.5. As depicted in FIG. 3B, channels 1 and 2 can only support vertical traffic. Thus, this configuration would only support off-bay devices on the top or bottom edges of a bay. It will be appreciated that other configurations are possible that can enable routing to off-bay destinations on the side edges of a bay. To enable routing to and from off-bay devices on all four edges of the bay, additional channels may be used.

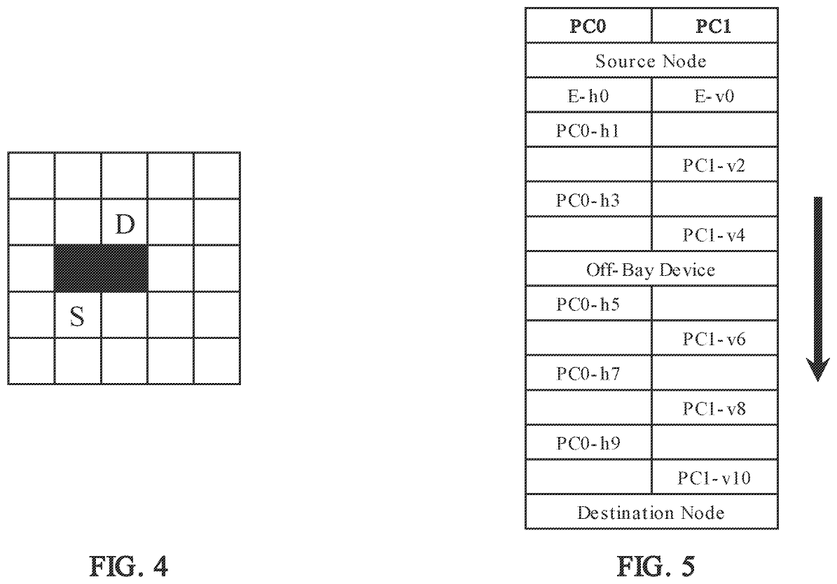

Dead dies present similar problems. Dead dies create situations in which multiple turns are utilized to route from one die to another. FIG. 4 illustrates a die array with two dead dies. In FIG. 4, moving a packet from the source die S to the destination die D involves routing around the two dead dies (shown in black). There is no way to get from the source die S to the destination die D without crossing a dead die unless multiple turns are allowed. The four-channel configuration depicted in FIG. 3A can allow more than one turn, but may still encounter problems and failures when there are multiple dead dies to route around.

While providing additional channels can alleviate potential problems, there can be a significant cost to doing so as additional channels involve additional hardware and can consume additional area. In some embodiments, different node rows/columns may be treated as independent channels, thereby increasing the number of channels available. While this can decrease the maximum bandwidth per channel, the impact can be mitigated because the overall bandwidth can be limited by the bandwidth at the edge of the die.

A plaid or striped pattern may be used to define additional channels. For example, every nth row or column of nodes can be separated into a group of virtual channels. As just one example, channel 0 above (PC0 network horizontal routes) could be split into 4 channels, and each 4^{th} row could be put into each channel. Thus, H-h0 would be comprised of rows 0, 4, 8, 12, etc., PC0-h1 would be comprised of rows 1, 5, 9, 13, etc., PC0-h2 would be comprised of rows 2, 6, 10, 14, etc., and PC0-h3 would be comprised of rows 3, 7, 11, 15, etc. Vertical channels can be similarly split so that, for example, PC1-v0 includes columns 0, 4, 8, 12, etc., and so forth.

FIG. 5 illustrates an example of routing along multiple channels according to some embodiments. As shown in FIG. 5, a packet can take multiple turns to get from the source node to the destination node. If a channel (e.g., PC0-h2, PC1-v3, etc.) ends at an edge of the bay, that route can terminate on an FPGA or a different bay over a Time-Triggered Protocol (TTP) or switch connection.

While this approach can alleviate some problems, there is a limited number of virtual and horizontal channels that can move packets from a source to a destination. One potential problem, however, is that when there are multiple dead dies such that a route may include many turns, routes can start from low-numbered channels because the rules may not permit turning from a higher-numbered channel to a lower-numbered channel. In some cases, however, a source node may not exist in a low-numbered row or column. Thus, the system may be configured to route packets to a low-numbered row or column before leaving the die.

Escape virtual channels (E channels) may be used to route packets to low-numbered channels. An escape channel may not leave the die and thus, while escape channels may add some complexity in managing tokens and tracking channels, they may not contribute to the number of channels to be supported by a Serializer/Deserializer (SerDes) controller. Advantageously, E channels can help keep local die traffic separated from global traffic, which may avoid the problem of local routes being impacted by global traffic that may get clogged at a die boundary, although the E network shares physical infrastructure with the PC0 and PC1 networks.

In the case of a packet that is being routed off the die, packets may be routed in an escape channel until it reaches the grout at the die edge. For example, if a packet in PC1-v6 is to be routed north along PC1-v2, the system can be configured to route it north in E-v0 until reached the grout, and the packet can be tagged as if it came from PC1-v2. Thus, when the packet leaves the die, it will be correctly routed as a PC1-v2 packet. Alternatively, in some cases, a packet may be routed along E-h0 and then turn onto PC1-v2. The skilled artisan will recognize that these are merely examples, and the system may route packets in a different manner consistent with this disclosure in some embodiments.

In some cases, packets may terminate at an FPGA. For example, if an on-bay portion of a route terminates at an FPGA, the system may be configured to route arriving packets at the grout to correct SerDes lanes so that the packets reach the correct target FPGA. In some embodiments, a single die can be connected to more than one FPGA. For example, along a north edge, each die may be connected to two FPGAs. In such a configuration, the two FPGAs would have the same column address, but could be assigned to different rows. Other configurations are possible, for example multiple FPGAs can share a single column and/or a single row.

At times, routing within a die can compete with routing from die to die. In some embodiments, to alleviate congestion of within-die packets, certain channels (e.g., high-numbered channels) may be reserved for usage only by the destination die. Thus, only local packets would operate in those channels, thereby avoiding clogging by packets that are routed across die boundaries.

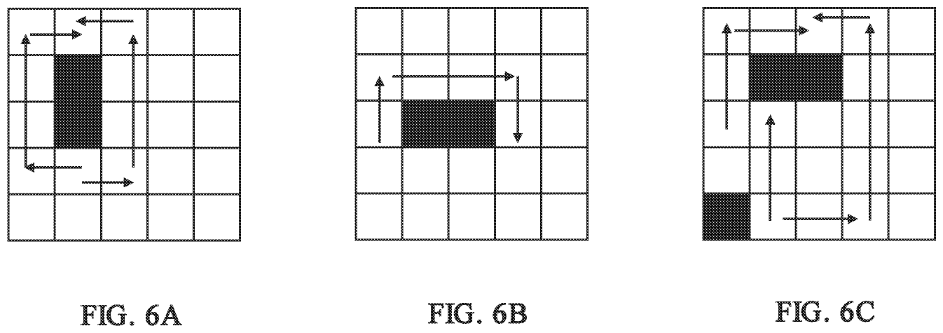

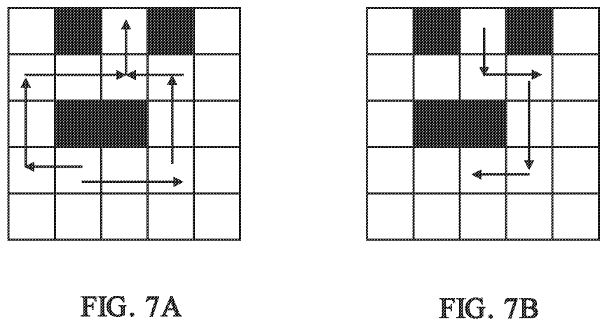

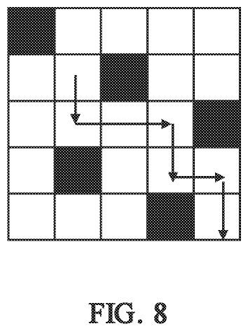

FIGS. 6A-6C depict example die arrays with a plurality of dead dies. These figures show various cases for routing around dead dies. In the examples in FIGS. 6A-6C, routing around the dead dies can be done in only two turns. Because few turns are implemented, this routing can be done with high bandwidth. As more dead dies are introduced, routing can become more complicated, for example, as depicted in FIGS. 7A-7B. Accordingly, the available bandwidth can be reduced routing around the dead dies in the die arrays of FIGS. 7A-7B. Depending on the number and distribution of dies, many turns may be involved to rout around dead dies, and routing may have relatively low bandwidth, for example, in the die array with dead dies depicted in FIG. 8. In FIGS. 6A-8, dead dies are shown in black.

### Grout Topology

Grout nodes have connections to the node array, SerDes controllers, and, in some cases, to adjacent (e.g., left and right) grout nodes. In some embodiments, packets may be routed from the node array to a SerDes controller, or from a SerDes controller to a node array, but may enter and leave the grout both on the node array or both on a SerDes controller. In addition to routing packets, the grout also serves a packet sorting function. In some embodiments, the grout may be divided into multiple channels, for example three channels traveling left to right and three traveling right to left, for both node to array transport and array to node transport. Each grout channel may include a plurality of virtual channels. For example, each grout channel may include PC0 and PC1 virtual channels, which may themselves be divided into Request Hi, Request Lo, and Data channels. Additionally, in some embodiments there may be channels that route directly to the local node's SerDes controllers.

When a packet arrives at the grout, for example on the array side, rules may determine which virtual channels the packet can be routed to. Additionally, packets may undergo a sorting function, for example to manage sorting of packets for routing to different FPGAs that may be connected behind different SerDes controllers. In some embodiments, there may be exactly one channel for a given physical channel or virtual channel, and packets may be sorted unambiguously to their destination channel. However, in other cases, the grout may use a thresholding mechanism to spread traffic across channels that are enabled for a given packet.

In some embodiments, a desired SerDes lane may be busy, and the packet may be routed to a different lane in the same row or column, e.g., to a neighboring lane. For example, a row or column may be divided into a plurality of lanes, for example 2 lanes, 3 lanes, 4 lanes, 5 lanes, 6 lanes, 7 lanes, 8 lanes, and so forth. In some embodiments, a packet can be routed to a different lane if, for example, one lane is not working.

As a packet is routed from grout node to grout node, its movements may be tracked and at each node, the packet may be allowed to continue straight, to turn, and so forth. In some embodiments, if a packet can continue straight and turn toward a SerDes controller, it may continue straight or turn based on a determination of whether there is room in the channel exit buffer. For example, in some cases, lanes may be busy and/or there may be a hardware defect that prevents a lane from working. In some embodiments, the grout may exercise per channel and/or per packet type control over which SerDes lanes can receive packets from which channels/packet type.

### Additional Embodiments

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein may be modified or otherwise implemented in various other ways without departing from the spirit and scope of the disclosure. Accordingly, this description is to be considered as illustrative and is for the purpose of teaching those skilled in the art the manner of making and using various embodiments of the disclosed IC assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures may also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

What is claimed is:

1. A method of dead die bypass routing, the method comprising:
routing a packet from a source die to an intermediate die via a first route, the first route comprising turning the packet from a first channel of a plurality of first channels to a second channel of the plurality of second channels based on one or more routing rules, the one or more routing rules allowing the first channel to route the packet to a subset of the plurality of second channels that includes the second channel, and the first channel being orthogonal to the second channel; and
routing the packet from the intermediate die to a destination die via a second route, the second route comprising turning the packet from the second channel to a third channel that is orthogonal to the second channel,
wherein a system on a wafer includes a die array comprising the source die, the intermediate die, the destination die, and at least one dead die, and
wherein the first route and the second route bypass the at least one dead die.

2. The method of claim 1, wherein the at least one dead die comprises two dead dies, and the first route and the second route bypass the two dead dies.

3. A method dead die bypass routing, the method comprising:
routing a packet from a first die to a second die by way a first channel of a plurality of first channels, wherein the first die, the second die, a third die, and a dead die are included in an array; and
routing the packet from the second die to the third die by way of a second channel of a plurality of second channels based on one or more routing rules, the one or more routing rules allowing the first channel to route the packet to a subset of the plurality of second channels that includes the second channel, and the second channel being orthogonal to the first channel such that routing the packet from the first die to the third die involves a turn,
wherein the method routes the packet around the dead die.

4. The method of claim 3, wherein routing the packet from the first die to the second die and the routing the packet from the second die to the third die comprises:
querying a routing table based at least in part on an address of the third die,
wherein the routing table complies with the one or more routing rules.

5. The method of claim 4, wherein the one or more routing rules prevent the packet from being routed in a loop.

6. The method of claim 5, wherein each channel of the plurality of first channels and each channel of the plurality of second channels is assigned a priority, and wherein the one or more routing rules disallows turns from a lower priority channel of the plurality of first channels to a higher priority channel of the plurality of second channels.

7. The method of claim 6, wherein a route from the first die to the third die is configured to end at a lowest priority first channel of the plurality of first channels or a lowest priority second channel of the plurality of second channels.

8. The method of claim 6, wherein the one or more routing rules allow the packet to be routed to an escape channel, the escape channel configured to allow the packet to move to a channel with a higher priority.

9. The method of claim 6, wherein a route from the first die to the third die includes a second turn from the second channel to a third channel, wherein the third channel has a lower priority than the second channel, and wherein second channel has a lower priority than the first channel.

10. The method of claim 4, wherein the routing table includes a default route, the default route to be used if there is not a defined route from the first die to the second die.

11. The method of claim 3, wherein the method routes the packet around at least two dead dies.

12. The method of claim 3, wherein the method comprises routing the packet with multiple turns.

13. The method of claim 3, wherein a system on a wafer includes the array.

14. The method of claim 3, further comprising routing the packet from the third die to a die outside of the array.

15. A processing system with dead die bypass routing, the processing system comprising:
a die array comprising a first die, a second die, a third die, and a dead die;
wherein the processing system is configured to route a packet from the first die to the third die by way of the second die to thereby bypass the dead die based on one or more routing rules implemented by circuitry of the processing system, the packet being routed by way of at least a first channel and a second channel, and the one or more routing rules allowing the first channel of a plurality of first channels to route the packet to a subset of a plurality of second channels that are orthogonal to the plurality of first channels.

16. The processing system of claim 15, wherein the processing system is configured to route the packet from the first die to the third die by way of multiple turns.

17. The processing system of claim 15, wherein the die array comprises a second dead die, and the processing system is configured to bypass the second dead die when routing the packet from the first die to the third die.

18. The processing system of claim 15, wherein the one or more routing rules prevent the packet from being routed in a loop.

19. The processing system of claim 15, wherein the processing system comprises a routing table storing information associated with the one or more routing rules.

20. The processing system of claim 19, wherein each channel of the plurality of first channels and each channel of the plurality of second channels is assigned a priority, and wherein the one or more routing rules disallow turns from a lower priority channel of the plurality of first channels to a higher priority channel of the plurality of second channels.

21. The processing system of claim 15, wherein the processing system is configured to generate neural network training data.
